(19) United States
(12) Patent Application Publication
(10) Pub. No.: US 2011/0125306 A1
(43) Pub. Date: May 26, 2011

(54) PROCESS FOR PRODUCING A BONE COMPLEMENT

(76) Inventors: Alberto Blay, Sao Paulo (BR); Marcelo Blay, Sao Paulo (BR); Tunchel Samy, Sao Paulo (BR)

(21) Appl. No.: 13/056,140

(22) PCT Filed: Apr. 28, 2009
(86) PCT No.: PCT/BR2009/000114

§ 371 Date: Jan. 27, 2011

(30) Foreign Application Priority Data
Jul. 29, 2008 (BR) 018080047767

(51) Int. Cl. G06F 17/50

(52) U.S. Cl. 700/98

(57) ABSTRACT

A process for producing a bone complement to to be carried out as a pre-operatory surgical procedure that includes the following steps: a) submitting the patient to a computerized tomography scan, in order to obtain images of the site of the defect to be grafted; b) analyzing the images obtained in a specific software; c) after the evaluation and diagnosis through the images, promoting the virtual treatment of the defect through a specific image manipulation software; d) transferring the manipulated images to 3D prototype producing equipment; e) generating the bone complement in a biomaterial; and f) promoting the cellular enrichment of the bone complement.

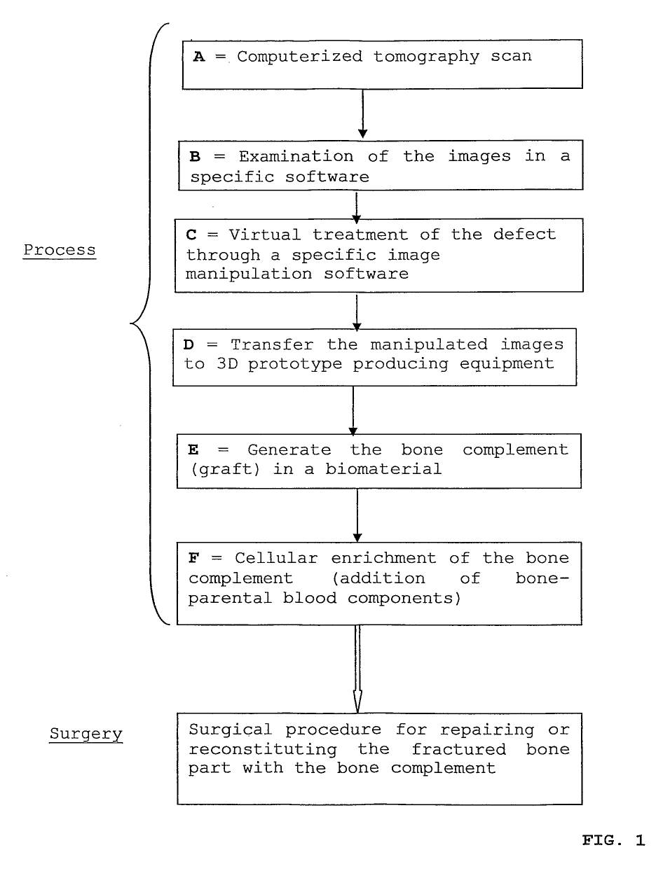

### DISCLOSURE OF THE INVENTION

The present invention is directed to a process for producing a bone complement to be used (graft), and more particularly to a process for producing a solid product made of alloplastic material designed for recovering the bone from computerized tomography scan (CT Scan) in association with a software (CAD/CAM) the purpose of which is the formation of bone tissue in the fields of medicine, dentistry and veterinary.

As is known by those skilled in the art, a solid graft made of alloplastic material is widely used to correct bone defects of any kind, the graft material being produced before the surgery is performed. The models (prototypes) are obtained from digital images (tomography), used to visualize bone defects and to allow for a surgical planning through such virtual models.

Despite the above mentioned solution to minimize the existing inconveniences found when the bone graft itself is dealt with, such solution that is conventionally used still brings about a number of inconveniences.

The inconvenience of this solution of an autogenous graft made of alloplastic material is the fact that it is an artisan work, since the handmade graft piece is fully based on an prototype while the surgery takes place, using autogenous bone or some kind of bone substitute. This characteristic demands a longer working time and a higher surgical risk, since the patient is exposed during the time the graft is produced, which graft is made “in loco”.

Another disadvantage of this solution is that, in view of the fact that the graft is produced during the surgery, the whole process becomes more complex.

Another disadvantage found in the solution that is conventionally used is related to the fact that the volume of material is restricted to the amount of the donator bed available, that may not suffice in certain situations.

Still another inconvenience, besides the surgical risk, is related to the fact that this solution causes the patient a significant local trauma, in view of the volume to be attained with the graft and due to the adaptation of the materials used in the production of the grafts, since the material is basically sculptured by using drills during the surgery, what makes it less precise.

Thus, in view of all such inconveniences, it can be said that the surgeries are frequently more complex, long and eventually less precise, thus diminishing the chances of success.

Therefore, one of the objects of the present invention is to provide a process for producing a bone complement to be used (graft) that may initially provide for the bone tissue formation in the fields of medicine, dentistry and veterinary.

Another object of the present invention is to provide a process for producing a bone complement to be used (graft) that can assure higher precision and agility in the surgical bone grafting procedures with safer and consistent results, diminishing the risks found in the techniques used until now.

Another object of the present invention is to provide a process for producing a bone complement to be used (graft) that eliminates either the need to remove bone blocks from other areas or the use of material from a bone bank (donators).

Another object of the present invention is to provide a process for producing a bone complement to be used (graft) that can assure a full precision when it is adapted to the patient.

Another object of the present invention is to provide a process for producing a bone complement to be used (graft) that allows for the manufacture of the graft (enriched with growth factors or not) in its final aspect, before the surgery based on virtual models is carried out.

These and other objects and advantages of the present invention are attained by a process for producing a bone complement to be used (graft) which comprises a pre-operatory surgical procedure comprising the following steps: a) submit the patient to a computerized tomography scan, in order to obtain images of the site of the defect to be grafted; b) analyze the images obtained in a specific software; c) after the evaluation and diagnosis through the images, promote the virtual treatment of the defect through a specific image manipulation software; d) transfer the manipulated images to 3D prototype producing equipment; e) generate the bone complement (graft) in a biomaterial; and f) promote the cellular enrichment of the bone complement (addition of bone-parental blood components). After the accurate production of the bone complement (graft), apply the same to the patient by means of reconstructive surgery, thus actually performing the repairing of the defect.

The present invention will be better understood hereinbelow through the accompanying drawing wherein the sole figure represents a block diagram that illustrates the sequential steps of the process.

In accordance with the sole illustration, the process for producing a bone complement to be used (graft) is carried out before the surgery for repairing or reconstituting the bone of the patient, who is then examined through the computerized tomography images that record the defect to be treated.

Thus, the process for producing a bone complement to be used (graft) comprises the steps:

a) submit the patient to a computerized tomography scan, in order to obtain the images of the site of the defect to be grafted;

b) analyze the images obtained in a specific software;

c) after the evaluation and medical diagnosis of the defect through these images, promote the virtual treatment of the defect through a proprietary image manipulation software;

d) transfer the manipulated images to 3D prototype producing equipment;

e) generate the bone complement (graft) in a biomaterial; and

f) promote, if desired, the cellular enrichment of the components).

After the bone complement (graft) is produced in its final finished form, the patient is submitted to the surgery for repairing, or reconstituting the defective part, comprising the application of the already finished bone complement without major adjustments during the surgical procedure. Although a form to perform the process has been described and illustrated, it should be stressed that alterations in the steps of this process, as well as the diversification of the operational parameters thereof are possible and attainable without departing from the scope of the present invention.

1. A process for producing a bone complement comprising a pre-operatory surgical procedure that comprises the steps of: a) submitting a patient to a computerized tomography scan to obtain images of a site of a defect to be grafted; b) analyzing the images obtained in a specific software; c) after an evaluation and a diagnosis through the images, promoting a virtual treatment of the defect through a specific image manipulation software; d) transferring the manipulated images to 3D prototype producing equipment; and e) generating the bone complement in a biomaterial.

2. The process for producing a bone complement according to claim 1, further comprising: f) promoting the cellular enrichment of the bone complement.

3. The process for producing a bone complement according to claim 1, further comprising the step of applying the biomaterial to the patient by means of reconstructive surgery, and thereby repairing the defect.

4. The process for producing a bone complement according to claim 2, wherein the cellular enrichment is bone parental blood components.
